(19) United States
(12) Patent Application Publication
(10) Pub. No.: US 2026/0110930 A1
(43) Pub. Date: Apr. 23, 2026

(54) DISPLAY DEVICE

(71) Applicant: Guangzhou China Star Optoelectronics Semiconductor Display Technology Co., Ltd., Guangzhou (CN)

(72) Inventor: Yuhua YANG, Guangzhou (CN)

(73) Assignee: Guangzhou China Star Optoelectronics Semiconductor Display Technology Co., Ltd., Guangzhou (CN)

(21) Appl. No.: 19/031,374

(22) Filed: Jan. 18, 2025

(30) Foreign Application Priority Data
Oct. 18, 2024 (CN) 202411464679.X

(51) Int. Cl. G02F 1/1333; G02F 1/1335; G02F 1/13357

(52) U.S. Cl. CPC G02F 1/13332; G02F 1/133512; G02F 1/133514; G02F 1/133615

(57) ABSTRACT

The present application provides a display device. The display device includes a display panel, a backlight module and a decorative strip. An array substrate of the display panel includes a first side surface, a color film substrate of the display panel includes a second side surface, and the second side surface is inwardly retracted relative to the first side surface. The backlight module includes a third side surface, and the first side surface is inwardly retracted relative to the third side surface. The decorative strip includes a planar component and a bending component, a first end of the planar component is lapped over a surface of the color film substrate away from the array substrate, and a second end of the planar component is connected to the bending component. The bending component extends towards the array substrate and is fixedly connected to the first side surface of the array substrate.

### CROSS-REFERENCE TO RELATED APPLICATION

The application claims priority to and the benefit of Chinese Patent Application No. 202411464679.X, filed on Oct. 18, 2024, the disclosure of which is incorporated herein by reference in its entirety.

### TECHNICAL FIELD

The present disclosure relates to display technologies, and in particular, to a display device.

### BACKGROUND

With the development of displays, users have increasingly higher demands for the appearance of the displays, such as thin and light, narrow-bezel, borderless, etc.

For existing displays, the bottom bezel of the display panel is usually fixed by a specific middle frame, but the thickness and the width of the middle frame are both large, causing the middle frame to protrude beyond the surface of the display panel, thereby making it impossible to achieve a visually borderless design of the display. While in the existing borderless displays, the middle frame structure of the display panel is removed, but this requires the display panel being inverted, meaning the array substrate is located on the light-emitting side of the display, and this requires more complex wiring and manufacturing processes, thereby increasing the cost of the product.

### SUMMARY

The present application provides a display device to mitigate the issues of high cost of the existing visually borderless display devices.

In order to solve the aforementioned issues, the technical solutions provided by the present application are as follows:

The present application provides a display device, including:
a display panel including an array substrate and a color film substrate arranged opposite to the array substrate, the array substrate including a bonding component and a first side surface close to the bonding component, the color film substrate including a second side surface close to the bonding component and parallel to the first side surface, and the second side surface being inwardly retracted relative to the first side surface;
a backlight module arranged on a side of the array substrate away from the color film substrate, the backlight module including a third side surface close to the bonding component and parallel to the first side surface, and the first side surface being inwardly retracted relative to the third side surface; and
a decorative strip including a planar component and a bending component, the bending component being arranged on a side of the planar component close to the backlight module, a first end of the planar component being lapped over a surface of the color film substrate away from the array substrate, a second end of the planar component being connected to the bending component, and the bending component extending towards the array substrate and being fixedly connected to the first side surface of the array substrate.

Other features and advantages of the present application will be described in detail in the following DETAILED DESCRIPTION section.

### BRIEF DESCRIPTION OF THE DRAWINGS

To more clearly illustrate the technical solutions of the present disclosure, a brief introduction to the drawings used in the description of the embodiments will be provided below. It is evident that the drawings described below represent only some embodiments of the present disclosure, and for those skilled in the art, other drawings can be derived from these drawings without creative labor.

To achieve a more comprehensive understanding of the present disclosure and its beneficial effects, the following description will be provided in conjunction with the accompanying drawings. In the following description, the same reference numerals will be used to denote a same component.

FIG. 1 is a schematic diagram of a structure of a display device provided from a first viewing angle according to an embodiment of the present disclosure;

FIG. 2 is a schematic diagram of film layers of a display panel in a display device according to an embodiment of the present disclosure;

FIG. 3 is a simplified cross-sectional diagram of a display device according to an embodiment of the present disclosure;

FIG. 4 is a schematic diagram of a first structure of a display panel, a decorative strip, a chip on film, and a circuit board in a display device according to an embodiment of the present disclosure;

FIG. 5 is a schematic diagram of a decorative strip in a display device according to an embodiment of the present disclosure;

FIG. 6 is a schematic diagram of a structure of a display device provided from a second viewing angle according to an embodiment of the present disclosure;

FIG. 7 is a schematic diagram of an enlarged view of an area A illustrated in FIG. 6;

FIG. 8 is a schematic diagram of a second structure of a display panel, a decorative strip, a chip on film, and a circuit board in a display device according to an embodiment of the present disclosure;

FIG. 9 is a schematic diagram of a structure of a display device provided from a third viewing angle according to an embodiment of the present disclosure;

FIG. 10 is a schematic diagram of a structure of a middle frame of a display device according to an embodiment of the present disclosure; and

FIG. 11 is a schematic diagram of a structure of a middle frame and a chip on film of a display device according to an embodiment of the present disclosure.

### LIST OF REFERENCE NUMERALS

Display device 10; upper frame 101; lower frame 102; left frame 103; right frame 104;
display panel 100, array substrate 110, first side surface 110a, first substrate 111, array layer 114, gate electrode layer 114a, gate insulating layer 114b, active layer 114c, source-drain electrode layer 114d, passivation layer 114e, pixel electrode layer 114f;
color film substrate 120; second side surface 120a; second substrate 121; color resist layer 122; color resist unit 122A; common electrode layer 123; light shielding layer 124; light shielding unit 124A;
backlight module 200; middle frame 210; third side surface 210a; side frame 211; first side frame 211a; first sub-frame 211aa; second sub-frame 211ab; second side frame 211b; third side frame 211c; fourth side frame 211d; horizontal frame 212; spacer layer 213; bottom frame 220; light guide plate 230; light source component 240; edge wraparound assembly 250; first sub-assembly 251; second sub-assembly 252; optical component 260;
decorative strip 300; planar component 310; bending component 320; first extension segment 321; first sub-component 321a; second sub-component 321b; second extension segment 322;
liquid crystal layer LC; frame adhesive 130; upper polarizer POL1; lower polarizer POL2; adhesive material 150;
chip on film 400; electrical connector 410; bending segment 411;
circuit board 500; and
outer frame 600.

### DETAILED DESCRIPTION

Technical solutions in the embodiments of the present disclosure will be clearly and completely described with reference to the accompanying drawings. It will be apparent that the described embodiments are only some of the embodiments of the present disclosure, but not all of them. Based on the embodiments in the present disclosure, other embodiments obtained by the skilled person in the art without creative labor all fall within the scope of the present disclosure.

The present application provides a display device, including:
a display panel including an array substrate and a color film substrate arranged opposite to the array substrate, the array substrate including a bonding component and a first side surface close to the bonding component, the color film substrate including a second side surface close to the bonding component and parallel to the first side surface, and the second side surface being inwardly retracted relative to the first side surface;
a backlight module arranged on a side of the array substrate away from the color film substrate, the backlight module including a third side surface close to the bonding component and parallel to the first side surface, and the first side surface being inwardly retracted relative to the third side surface; and
a decorative strip including a planar component and a bending component, the bending component being arranged on a side of the planar component close to the backlight module, a first end of the planar component being lapped over a surface of the color film substrate away from the array substrate, a second end of the planar component being connected to the bending component, and the bending component extending towards the array substrate and being fixedly connected to the first side surface of the array substrate.

Optionally, the bending component includes multiple first extension segments arranged at intervals, and at least one of the first extension segments includes a first sub-component and a second sub-component connected to each other, one end of the first sub-component is connected to the planar component, the other end of the first sub-component extends in a first direction, ends of the first sub-component are located between the first end of the planar component and the second end of the planar component, and the first direction is a direction from the first end of the planar component to the second end of the planar component; and wherein the second sub-component is arranged at an angle to the first sub-component, and the second sub-component extends towards a side away from the planar component, and the second sub-component is fixedly connected to the first side surface of the array substrate.

Optionally, the second sub-component extend along a second direction, and the second direction is perpendicular to the first direction.

Optionally, a surface of the first sub-component close to the planar component is in contact with a surface of the planar component close to the first sub-component.

Optionally, the bending component further includes multiple second extension segments arranged at intervals, and one of the second extension segments is arranged between two adjacent first sub-component;
wherein one end of the second extension segment is connected to the planar component, the other end of the second extension segment extends along the first direction, and in the first direction, a width of the second extension segment is less than a width of the first sub-component.

Optionally, the display device further includes a chip on film, the chip on film includes electrical connectors arranged at intervals, and one end of the electrical connector is bonded and connected to the bonding component, and the other end of the electrical connector passes through an area between the second sub-components and is bent towards the side of the array substrate away from the color film substrate.

Optionally, the electrical connector includes a bending segment corresponding to the decorative strip, and an orthographic projection of the bending segment on the planar component does not overlap with the second extension segment.

Optionally, the backlight module includes a first side frame corresponding to the decorative strip, the first side frame includes multiple first sub-frames and multiple second sub-frames arranged at intervals, the first sub-frames correspond to the first extension segments, and the second sub-frames correspond to the second extension segments; and
wherein two ends of the second sub-frame along the first direction are inwardly retracted relative to two ends of the first sub-frame along the first direction, and the electrical connector is bent towards the side of the array substrate away from the color film substrate after passing through an area between the second extension segment and the second sub-frame.

Optionally, the display device further includes a circuit board, and the circuit board is fixed to a side of a bottom frame of the backlight module away from the display panel; and the chip on film is bent to the side of the bottom frame away from the display panel, and is electrically connected to the circuit board.

Optionally, an end surface of the second sub-component away from the planar component extends beyond a surface of the array substrate away from the color film substrate.

Optionally, the display device further includes a lower polarizer arranged on the surface of the array substrate away from the color film substrate, and the end surface of the second sub-component away from the planar component extends beyond a surface of the lower polarizer away from the color film substrate.

Optionally, the end surface of the second sub-component away from the planar component is located on a same plane as the surface of the array substrate away from the color film substrate.

Optionally, the second sub-component is arranged separately from the backlight module.

Optionally, the display device further includes an adhesive material arranged between the second sub-component and the first side surface, and the second sub-component is fixedly connected to the first side surface by the adhesive material.

Optionally, an orthographic projection of the third side surface on the planar component is located within the planar component.

Optionally, the display device further includes an upper polarizer arranged on a surface of the color film substrate away from the array substrate, and the upper polarizer and the planar component are arranged at intervals; and
wherein a thickness of the upper polarizer is equal to a thickness of the planar component.

Optionally, the array substrate includes a first substrate and an array layer located on the first substrate, and the array layer includes multiple thin film transistors; and
wherein the thin film transistor includes a gate electrode layer located on the first substrate, a gate insulating layer located on the gate electrode layer, an active layer located on the gate insulating layer, a source-drain electrode layer located on the active layer, a passivation layer located on the source-drain electrode layer, and a pixel electrode layer located on the passivation layer.

Optionally, the color film substrate includes a second substrate, a color resist layer located on the second substrate, a light shielding layer arranged in a same layer as the color resist layer, and a common electrode layer located on a side of the color resist layer away from the second substrate.

Optionally, the color resist layer includes multiple color resist units arranged at intervals, and the light shielding layer includes a light shielding unit arranged between two adjacent color resist units.

Optionally, the display device further includes an outer frame, and the outer frame is a shell structure with a containing cavity; the display panel, the backlight module, and decorative strip are arranged within the outer frame; and an end surface of the outer frame away from the backlight module is located in the same plane as the surface of the planar component away from the backlight module.

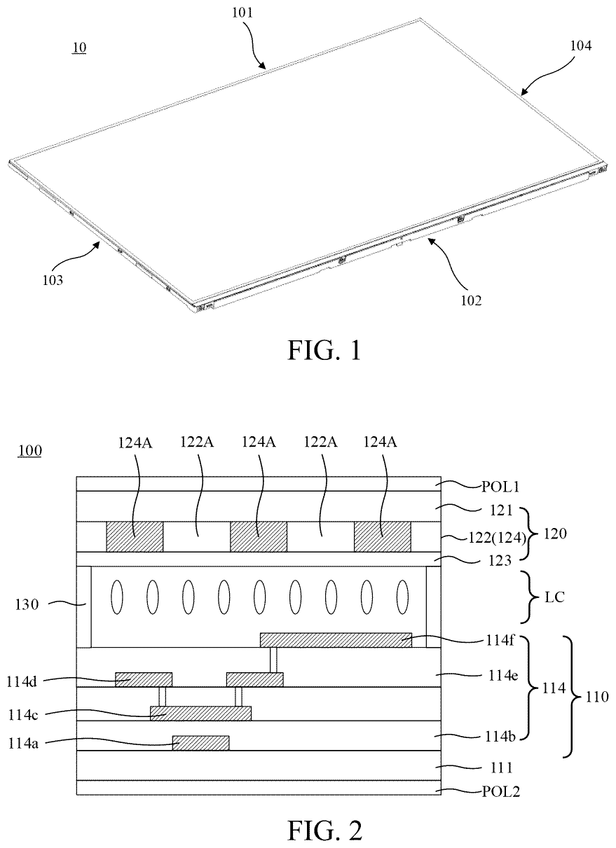

Please refer to FIG. 1 to FIG. 10. The present application provides a display device 10, the display device 10 includes a display panel 100, a backlight module 200, and a decorative strip 300, and the backlight module 200 is arranged on a side of an array substrate 110 away from a color film substrate 120.

In the present embodiment, the display panel 100 includes the array substrate 110 and the color film substrate 120 arranged opposite to the array substrate 110, the array substrate 110 includes a bonding component 140 and a first side surface 110a close to the bonding component 140, the color film substrate 120 includes a second side surface 120a close to the bonding component 140 and parallel to the first side surface 110a, and the second side surface 120a is inwardly retracted relative to the first side surface 110a.

In the present embodiment, the backlight module 200 includes a third side surface 210a close to the bonding component 140 and parallel to the first side surface 110a, and the first side surface 110a is inwardly retracted relative to the third side surface 210a.

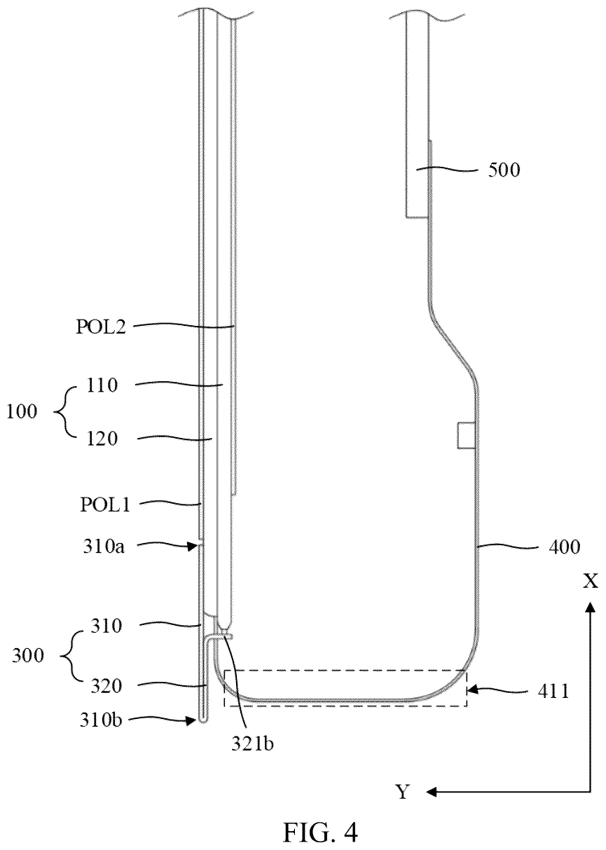

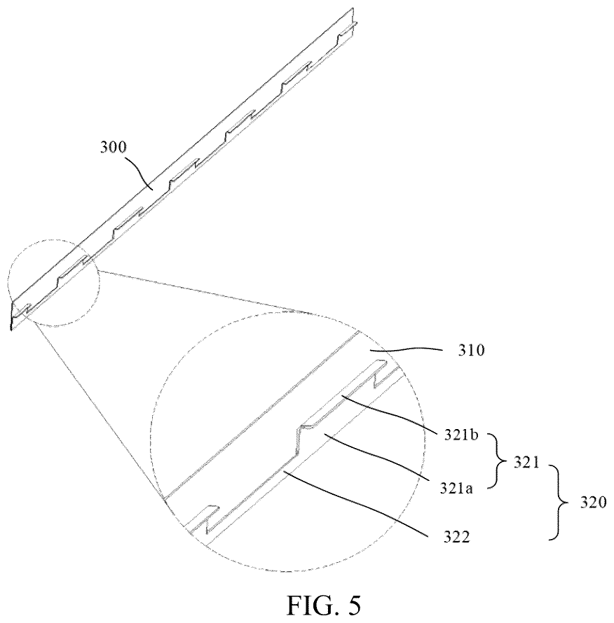

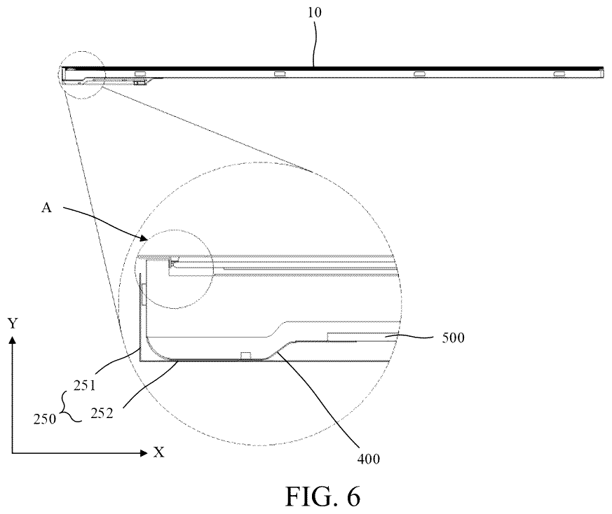

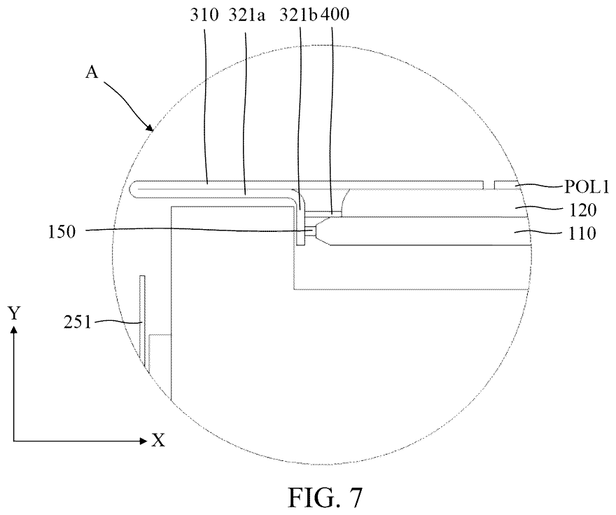

Please refer to FIG. 4. The decorative strip 300 includes a planar component 310 and a bending component 320, the bending component 320 is arranged on a side of the planar component 310 close to the backlight module 200, a first end 310a of the planar component 310 is lapped over a surface of the color film substrate 120 away from the array substrate 110, a second end 310b of the planar component 310 is connected to the bending component 320, and the bending component 320 extends towards the array substrate 110 and is fixedly connected to the first side surface 110a of the array substrate 110.

Please refer to FIG. 1. The display device 10 includes an upper frame 101, a lower frame 102, a left frame 103, and a right frame 104, and the lower frame 102 is usually provided with the bonding component 140 and a chip on film 400 connected to the bonding component 140, and thus a width of the lower frame 102 is usually wider than the other three frames; while in the present application, the decorative strip 300 is arranged in an area where the lower frame 102 is located, the first end 310a of the planar component 310 of the decorative strip 300 is lapped over the surface of the color film substrate 120 away from the array substrate 110, the bending component 320 of the decorative strip 300 extends towards the array substrate 110 and is fixedly connected to the first side surface 110a of the array substrate 110, thereby achieving the encapsulation of the bottom of the display panel 100 and removing the middle frame used for encapsulating the bottom of the display panel 100. Furthermore, because a thickness of the planar component 310 in the present application is relatively small, the planar component 310 is lapped over the surface of the color film substrate 120, so that achieve a borderless view on the display surface of the device 10. Additionally, the display panel 100 does not need to be inverted, which simplifies the decorative strip 300 of the bottom frame of the display panel 100 and reduces the cost of the product.

It should be noted that a material of the decorative strip 300 in the present application may be a metal sheet or other non-metal thin material. For example, the material of the decorative strip 300 may be stainless steel.

It should be noted that a thickness of the decorative strip 300 in the present application may range from 0.1 mm to 0.2 mm. For example, the thickness of the decorative strip 300 in the present application may be 0.15 mm.

It should be noted that the display surface of the display device 10 in the present application is a surface of the display panel 100 away from the backlight module 200.

The technical solutions of the present application will be described below in conjunction with specific embodiments.

Please refer to FIG. 2. The array substrate 110 may include a first substrate 111 and an array layer 114 located on the first substrate 111, and the array layer 114 may include multiple thin film transistors. The thin film transistors may be etch-blocking type, back channel etched type, or may be classified based on the position of the gate electrode and the active layer 114c as bottom-gate thin film transistors, top-gate thin film transistors, etc.

For example, a bottom-gate thin film transistor may include a gate electrode layer 114a located on the first substrate 111, a gate insulating layer 114b located on the gate electrode layer 114a, an active layer 114c located on the gate insulating layer 114b, a source-drain electrode layer 114d located on the active layer 114c, a passivation layer 114e located on the source-drain electrode layer 114d, and a pixel electrode layer 114f located on the passivation layer 114e.

Please refer to FIG. 2. The color film substrate 120 may include a second substrate 121, a color resist layer 122 located on the second substrate 121, a light shielding layer 124 arranged in a same layer as the color resist layer 122, and a common electrode layer 123 located on a side of the color resist layer 122 away from the second substrate 121. The electric field formed by the common electrode layer 123 and the pixel electrode layer 114f drives liquid crystal molecules in the liquid crystal layer LC in the display panel 100 to deflect.

In the present embodiment, the color resist layer 122 includes multiple color resist units 122A arranged at intervals, and the light shielding layer 124 includes a light shielding unit 124A arranged between two adjacent color resist units 122A, and multiple light shielding units 124A may form a mesh structure.

Please refer to FIG. 2. The display panel 100 further includes a frame adhesive 130 arranged between the array substrate 110 and the color film substrate 120, and the frame adhesive 130 is located at the periphery of the display panel 100.

In the present embodiment, the materials of the first substrate 111 and the second substrate 121 may be prepared from materials such as glass, quartz, polyimide, etc.

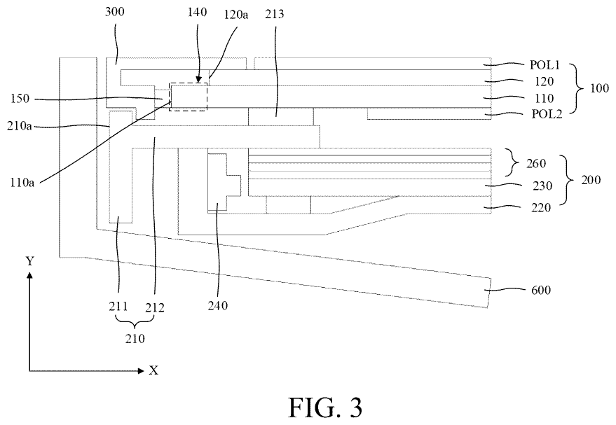

Please refer to FIG. 3. The backlight module 200 includes a middle frame 210 and a bottom frame 220, the middle frame 210 and the bottom frame 220 are enclosed to form a containing space. Within the containing space, a light guide plate 230 is provided, a light source component 240 is arranged on a side of the light guide plate 230 close to the third side surface 210a, and an optical component 260 is arranged on a side of the light guide plate 230 close to the display panel 100. The optical component 260 may include a lower prism sheet, a lower diffusion sheet, an upper diffusion sheet, an upper prism sheet, etc.

Please refer to FIG. 3. The middle frame 210 includes a side frame 211 and a horizontal frame 212 connected to each other, the horizontal frame 212 extends from the side frame 211 towards the center of the display device 10, and both the side frame 211 and the horizontal frame 212 are continuous annular structures; additionally, a spacer layer 213 is arranged on the horizontal frame 212, and the peripheral surface of the array substrate 110 facing the backlight module 200 is lapped over the spacer layer 213.

It should be noted that since an area where the lower frame 102 of the display device 10 is located includes structures such as the light source component 240, etc., an extension length of the horizontal frame 212 in the area is greater than an extension length of the other frames.

It should be noted that the backlight module 200 in the present application may be either a direct-lit backlight module or an edge-lit backlight module. The following embodiments will be described with reference to the edge-lit backlight module illustrated in FIG. 3.

Please refer to FIG. 2 and FIG. 3. The display device 10 further includes an upper polarizer POL1 and a lower polarizer POL2. The upper polarizer POL1 is arranged on a surface of the color film substrate 120 away from the array substrate 110, and the lower polarizer POL2 is arranged on a surface of the array substrate 110 away from the color film substrate 120. That is, the upper polarizer POL1 is arranged on a surface of the second substrate 121 away from the array substrate 110, and the lower polarizer POL2 is arranged on a surface of the first substrate 111 away from the color film substrate 120.

Please refer to FIG. 3 and FIG. 4. The planar component 310 is lapped over a surface of the color film substrate 120, that is, the planar component 310 is lapped over a surface of the second substrate 121 away from the array substrate 110. Both the planar component 310 and the upper polarizer POL1 are located on the surface of the second substrate 121. In order to ensure that the appearance of the display device 10 is flat, a thickness of the upper polarizer POL1 and a thickness of the planar component 310 in the present application may be the same.

It should be noted that due to process tolerances, the thickness of the upper polarizer POL1 and the thickness of the planar component 310 may be the same in terms of effect, with the difference between the two being within a tolerance range, so that the display surface of the display device 10 appears visually as a flat plane.

Please refer to FIG. 3 and FIG. 4. The upper polarizer POL1 and the planar component 310 are arranged at intervals, for example, a distance between the upper polarizer POL1 and the planar component 310 may be 0.8 mm.

Please refer to FIG. 5. The bending component 320 includes multiple first extension segments 321 arranged at intervals, and at least one of the first extension segments 321 includes a first sub-component 321a and a second sub-component 321b connected to each other, one end of the first sub-component 321a is connected to the planar component 310, the other end of the first sub-component 321a extends in a first direction X, ends of the first sub-component 321a are located between the first end 310a of the planar component 310 and the second end 310b of the planar component 310, and the first direction X is a direction from the first end 310a of the planar component 310 to the second end 310b of the planar component 310.

Please refer to FIG. 5 to FIG. 7. The second sub-component 321b is arranged at an angle to the first sub-component 321a, and the second sub-component 321b extends towards a side away from the planar component 310, and the second sub-component 321b is fixedly connected to the first side surface 110a of the array substrate 110.

In the present embodiment, the second sub-component 321b may extend diagonally or longitudinally, and as illustrated in FIG. 6 of the present application, the second sub-component 321b may extend along a second direction Y, and the second direction Y may be perpendicular to the first direction X.

It should be noted that the planar component 310 and the bending component 320 of the present application may be formed by bending a same raw material. Additionally, a surface of the first sub-component 321a close to the planar component 310 is in contact with a surface of the planar component 310 close to the first sub-component 321a.

Please refer to FIG. 6 and FIG. 7. The display device 10 further includes an adhesive material 150 arranged between the second sub-component 321b and the first side surface 110a, and the second sub-component 321b is fixedly connected to the first side surface 110a by the adhesive material 150.

In the present embodiment, the adhesive material 150 may be UV glue, that is each second sub-component 321b is adhered to the first side surface 110a by the adhesive material 150, thereby fixedly connecting the decorative strip 300 to the display panel 100.

Please refer to FIG. 5. The bending component 320 further includes multiple second extension segments 322 arranged at intervals, and one of the second extension segments 322 is arranged between two adjacent first sub-component 321a. One end of the second extension segment 322 is connected to the planar component 310, and the other end of the second extension segment 322 extends along the first direction X.

Please refer to FIG. 4 and FIG. 6 to FIG. 8. The display device 10 further includes a chip on film 400, the chip on film 400 includes electrical connectors 410 arranged at intervals, and one end of the electrical connector 410 is bonded and connected to the bonding component 140, and the other end of the electrical connector 410 passes through an area between the second sub-components 321b and is bent towards the side of the array substrate 110 away from the color film substrate 120.

In the present embodiment, the chip on film 400 needs to be bent towards the side of the array substrate 110 away from the color film substrate 120. Since the decorative strip 300 is arranged in the area where the lower frame 102 is located, the second extension segment 322 is not provided with a second sub-component 321b, unlike the first extension segment 321 in the present application, and the electrical connectors 410 of the chip on film 400 can pass through an area between the second sub-components 321b and be bent towards the side of the array substrate 110 away from the color film substrate 120.

In the present embodiment, due to a thickness of the second extension segment 322 is relatively small, during the process of bending the chip on film 400 to the side of the array substrate 110 away from the color film substrate 120, the chip on film 400 may interfere with an edge of the second extension segment 322, and the edge of the second extension segment 322 may cut off lines on the chip on film 400, resulting in an abnormality of the chip on film 400. In order to avoid the interference between the chip on film 400 and the second extension segment 322, in the first direction X, a width of the second extension segment 322 is less than a width of the first sub-component 321a, that is, the edge of the second extension segment 322 is inwardly retracted relative to an edge of the first sub-component 321a, thereby providing some space for the electrical connector 410 to pass through the area between the second sub-components 321b, and avoiding interference between the electrical connector 410 and the second extension segment 322.

In the present embodiment, to further avoid interference between the electrical connector 410 and the second extension segment 322, the electrical connector 410 includes a bending segment 411 corresponding to the decorative strip 300, and an orthographic projection of the bending segment 411 on the planar component 310 does not overlap with the second extension segment 322.

Please refer to FIG. 6 and FIG. 7. An end surface of the second sub-component 321b away from the planar component 310 extends beyond a surface of the array substrate 110 away from the color film substrate 120.

In the present embodiment, to increase the adhering area between the second sub-component 321b and the array substrate 110, the end surface of the second sub-component 321b extends beyond the surface of the array substrate 110 away from the color film substrate 120. Since the bottom of the array substrate 110 is the first substrate 111, it means that the end surface of the second sub-component 321b extends beyond the surface of the first substrate 111 away from the color film substrate 120, and the end surface of the second sub-component 321b away from the planar component 310 does not extend beyond a surface of the lower polarizer POL2 away from the color film substrate 120.

Please refer to FIG. 9. Based on FIG. 4, the end surface of the second sub-component 321b away from the planar component 310 may extend beyond a surface of the lower polarizer POL2 away from the color film substrate 120; alternatively, the end surface of the second sub-component 321b away from the planar component 310 may be located on a same plane as the surface of the array substrate 110 away from the color film substrate 120.

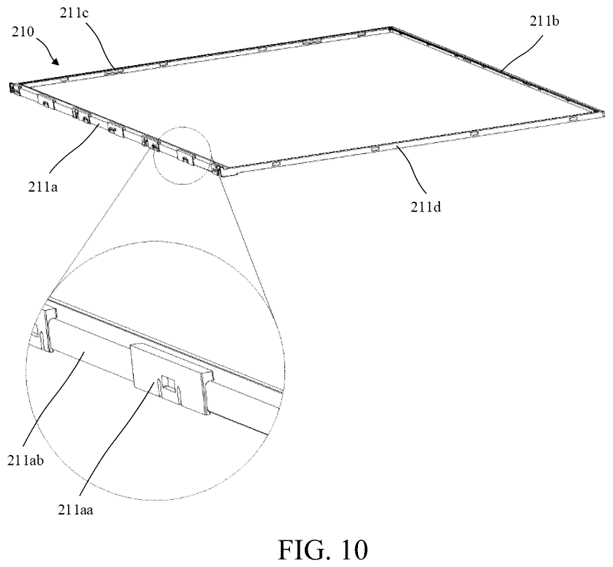

Please refer to FIG. 10. The side frame 211 of the middle frame 210 may include a first side frame 211a, a second side frame 211b, a third side frame 211c, and a fourth side frame 211d connected to each other. The first side frame 211a corresponds to the lower frame 102, the second side frame 211b corresponds to the upper frame 101, the third side frame 211c corresponds to the left frame 103, and the fourth side frame 211d corresponds to the right frame 104. The first side frame 211a includes multiple first sub-frames 211aa and multiple second sub-frames 211ab arranged at intervals, the first sub-frames 211aa correspond to the first extension segments 321, the second sub-frames 211ab correspond to the second extension segments 322, and both the first sub-frames 211aa and the second sub-frames 211ab extend along the first direction X.

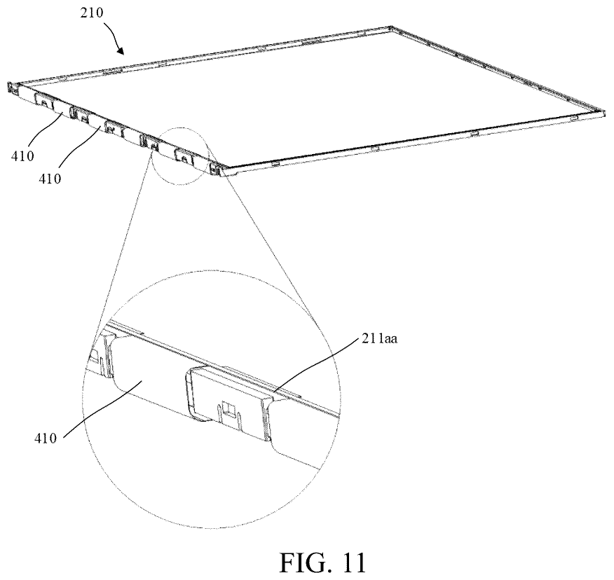

Please refer to FIG. 10. Two ends of the second sub-frame 211ab in the first direction X are inwardly retracted relative to two ends of the first sub-frame 211aa in the first direction X, and the electrical connector 410 is bent towards the side of the array substrate 110 away from the color film substrate 120 after passing through an area between the second extension segment 322 and the second sub-frame 211ab, referring specifically to FIG. 11.

In the present embodiment, the chip on film 400 of the present application can be bent to the back surface of the backlight module 200 away from the display panel 100, and the first sub-frame 211aa extends towards an area where the first extension segment 321 is located, and the surface of the first sub-frame 211aa close to the first extension segment 321 extends beyond the surface of the array substrate 110 away from the backlight module 200, and therefore the chip on film 400 may interfere with the middle frame 210 when the chip on film 400 is bent. In the present application, the middle frame 210 is provided with multiple first sub-frames 211aa and multiple second sub-frames 211ab arranged at intervals, and the two ends of the second sub-frames 211ab are inwardly retracted relative to the two ends of the first sub-frames 211aa, allowing the electrical connector 410 to pass through the area between the second extension segment 322 and the second sub-frame 211ab, and bend to the side of the backlight module 200 away from the display panel 100.

It should be noted that since the decorative strip 300 is relatively thin and easy to deform, and the decorative strip 300 is arranged close to the middle frame 210. Thus, in order to ensure the shape of the decorative strip 300, referring to FIG. 7, the first sub-component 321a is arranged separately from the middle frame 210, the second sub-component 321b is arranged separately from the middle frame 210, a distance between the first sub-component 321a and the middle frame 210 may be 0.5 mm, and a distance between the second sub-component 321b and the middle frame 210 may be 0.5 mm.

It should be noted that since the chip on film 400 is bent only in the area where the lower frame 102 is located in the display device 10, the middle frame 210 of the present application is provided with first sub-frames 211aa and second sub-frames 211ab arranged at intervals and arranged only in the area where the lower frame 102 is located.

Please refer to FIG. 7. To achieve the borderless view on the display surface of the display device 10, an orthographic projection of the third side surface 210a on the planar component 310 is located within the planar component 310, that is, the third side surface 210a may be a side surface of the middle frame 210 in the area where the lower frame 102 is located; for example, the third side surface 210a may be inwardly retracted relative to the second end 310b of the planar component 310, so that the planar component 310 can completely cover the edge of the middle frame 210 in the area where the lower frame 102 is located.

Please refer to FIG. 6. The display device 10 further includes an edge wraparound assembly 250, and the edge wraparound assembly 250 includes a first sub-assembly 251 and a second sub-assembly 252 connected to each other. The first sub-assembly 251 is arranged on a side of the third side surface 210a away from the display panel 100, and the second sub-assembly 252 is arranged on the side of the backlight module 200 away from the display panel 100.

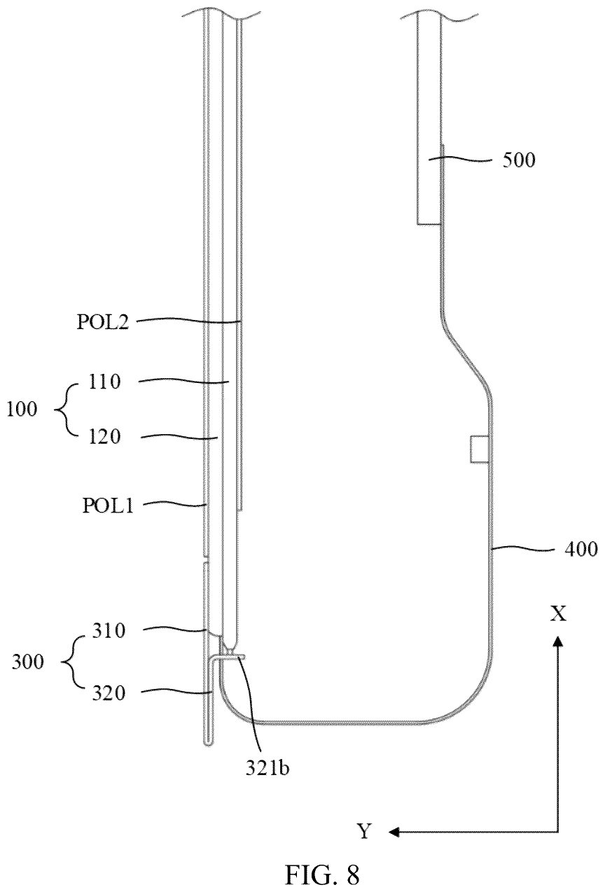

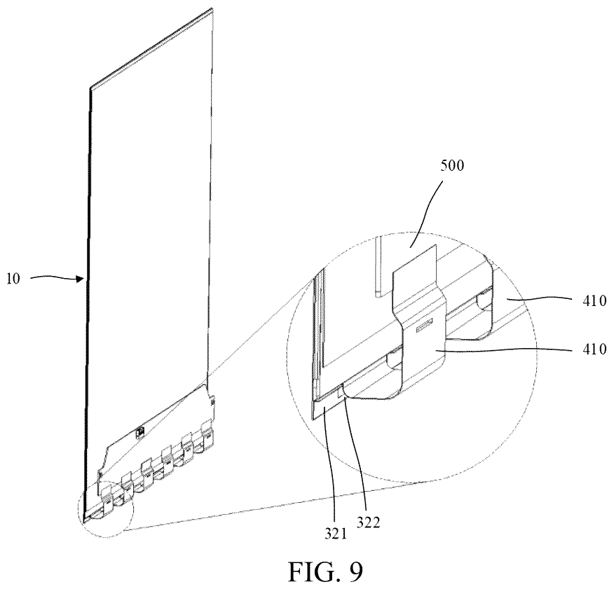

Please refer to FIG. 4, FIG. 6, FIG. 8, and FIG. 9. The display device 10 further includes a circuit board 500, and the circuit board 500 is fixed to a side of the bottom frame 220 away from the display panel 100. The chip on film 400 is bent to the side of the bottom frame 220 away from the display panel 100, and is electrically connected to the circuit board 500.

Please refer to FIG. 3. The display device 10 further includes an outer frame 600, and the outer frame 600 is a shell structure with a containing cavity. The display panel 100, the backlight module 200, and decorative strip 300 are arranged within the outer frame 600. An end surface of the outer frame 600 away from the backlight module 200 and the surface of the planar component 310 away from the backlight module 200 may be located in a same plane, thereby achieving the borderless view on the display surface of the device 10.

It should be noted that the display device of the present application may be any product or component with display capabilities, such as a mobile phone, a tablet computer, a television, a monitor, a laptop computer, a digital photo frame, a navigation device, etc.

In the description of the present disclosure, it is to be understood that the terms “first”, “second” and the like are used for descriptive purposes only and are not to be construed as indicating or implying relative importance or implying an amount of indicated technical features. Thus, features defined with “first” and “second” may explicitly or implicitly include one or more of the feature. In the description of the present disclosure, “multiple” means two or more, unless otherwise expressly and specifically limited.

In the aforementioned embodiments, the description of each embodiment focuses on different perspectives, and contents not described in detail in a certain embodiment may be referred to the related description in other embodiments.

The embodiments, implementations, and related technical features of the present application can be combined and interchanged with each other without conflict.

The above are merely preferred embodiments of the present application and are not intended to limit the scope of the present application in any way. Any simple modifications, equivalent changes, or adaptations made to the aforementioned embodiments based on the technical essence of the present application without departing from the content of the technical solutions of the present application shall still be within the scope of the present application.

What is claimed is:

1. A display device, comprising:
a display panel comprising an array substrate and a color film substrate arranged opposite to the array substrate, the array substrate comprising a bonding component and a first side surface close to the bonding component, the color film substrate comprising a second side surface close to the bonding component and parallel to the first side surface, and the second side surface being inwardly retracted relative to the first side surface;
a backlight module arranged on a side of the array substrate away from the color film substrate, the backlight module comprising a third side surface close to the bonding component and parallel to the first side surface, and the first side surface being inwardly retracted relative to the third side surface; and
a decorative strip comprising a planar component and a bending component, the bending component being arranged on a side of the planar component close to the backlight module, a first end of the planar component being lapped over a surface of the color film substrate away from the array substrate, a second end of the planar component being connected to the bending component, and the bending component extending towards the array substrate and being fixedly connected to the first side surface of the array substrate.

2. The display device of claim 1, wherein the bending component comprises multiple first extension segments arranged at intervals, and at least one of the first extension segments comprises a first sub-component and a second sub-component connected to each other, one end of the first sub-component is connected to the planar component, the other end of the first sub-component extends in a first direction, ends of the first sub-component are located between the first end of the planar component and the second end of the planar component, and the first direction is a direction from the first end of the planar component to the second end of the planar component; and
wherein the second sub-component is arranged at an angle to the first sub-component, and the second sub-component extends towards a side away from the planar component, and the second sub-component is fixedly connected to the first side surface of the array substrate.

3. The display device of claim 2, wherein the second sub-component extend along a second direction, and the second direction is perpendicular to the first direction.

4. The display device of claim 2, wherein a surface of the first sub-component close to the planar component is in contact with a surface of the planar component close to the first sub-component.

5. The display device of claim 2, wherein the bending component further comprises multiple second extension segments arranged at intervals, and one of the second extension segments is arranged between two adjacent first sub-component;
wherein one end of the second extension segment is connected to the planar component, the other end of the second extension segment extends along the first direction, and in the first direction, a width of the second extension segment is less than a width of the first sub-component.

6. The display device of claim 5, wherein the display device further comprises a chip on film, the chip on film comprises electrical connectors arranged at intervals, and one end of the electrical connector is bonded and connected to the bonding component, and the other end of the electrical connector passes through an area between the second sub-components and is bent towards the side of the array substrate away from the color film substrate.

7. The display device of claim 6, wherein the electrical connector comprises a bending segment corresponding to the decorative strip, and an orthographic projection of the bending segment on the planar component does not overlap with the second extension segment.

8. The display device of claim 6, wherein the backlight module comprises a first side frame corresponding to the decorative strip, the first side frame comprises multiple first sub-frames and multiple second sub-frames arranged at intervals, the first sub-frames correspond to the first extension segments, and the second sub-frames correspond to the second extension segments; and
wherein two ends of the second sub-frame along the first direction are inwardly retracted relative to two ends of the first sub-frame along the first direction, and the electrical connector is bent towards the side of the array substrate away from the color film substrate after passing through an area between the second extension segment and the second sub-frame.

9. The display device of claim 6, wherein the display device further comprises a circuit board, and the circuit board is fixed to a side of a bottom frame of the backlight module away from the display panel; and the chip on film is bent to the side of the bottom frame away from the display panel, and is electrically connected to the circuit board.

10. The display device of claim 2, wherein an end surface of the second sub-component away from the planar component extends beyond a surface of the array substrate away from the color film substrate.

11. The display device of claim 10, wherein the display device further comprises a lower polarizer arranged on the surface of the array substrate away from the color film substrate, and the end surface of the second sub-component away from the planar component extends beyond a surface of the lower polarizer away from the color film substrate.

12. The display device of claim 2, wherein the end surface of the second sub-component away from the planar component is located on a same plane as the surface of the array substrate away from the color film substrate.

13. The display device of claim 2, wherein the second sub-component is arranged separately from the backlight module.

14. The display device of claim 2, wherein the display device further comprises an adhesive material arranged between the second sub-component and the first side surface, and the second sub-component is fixedly connected to the first side surface by the adhesive material.

15. The display device of claim 1, wherein an orthographic projection of the third side surface on the planar component is located within the planar component.

16. The display device of claim 1, wherein the display device further comprises an upper polarizer arranged on a surface of the color film substrate away from the array substrate, and the upper polarizer and the planar component are arranged at intervals; and
wherein a thickness of the upper polarizer is equal to a thickness of the planar component.

17. The display device of claim 1, wherein the array substrate comprises a first substrate and an array layer located on the first substrate, and the array layer comprises multiple thin film transistors; and
wherein the thin film transistor comprises a gate electrode layer located on the first substrate, a gate insulating layer located on the gate electrode layer, an active layer located on the gate insulating layer, a source-drain electrode layer located on the active layer, a passivation layer located on the source-drain electrode layer, and a pixel electrode layer located on the passivation layer.

18. The display device of claim 1, wherein the color film substrate comprises a second substrate, a color resist layer located on the second substrate, a light shielding layer arranged in a same layer as the color resist layer, and a common electrode layer located on a side of the color resist layer away from the second substrate.

19. The display device of claim 18, wherein the color resist layer comprises multiple color resist units arranged at intervals, and the light shielding layer comprises a light shielding unit arranged between two adjacent color resist units.

20. The display device of claim 1, wherein the display device further comprises an outer frame, and the outer frame is a shell structure with a containing cavity; the display panel, the backlight module, and decorative strip are arranged within the outer frame;
and an end surface of the outer frame away from the backlight module is located in a same plane as the surface of the planar component away from the backlight module.
